(19) United States
(12) Patent Application Publication
(10) Pub. No.: US 2014/0004943 A1
(43) Pub. Date: Jan. 2, 2014

(54) ELECTRONIC DEVICE, CONTROL METHOD THEREOF, AND RECORDING MEDIUM

(71) Applicant: SQUARE ENIX HOLDINGS CO., LTD., Tokyo (JP)

(72) Inventor: Tadashi Tsushima, Tokyo (JP)

(73) Assignee: SQUARE ENIX HOLDINGS CO., LTD., Tokyo (JP)

(21) Appl. No.: 13/899,663

(22) Filed: May 22, 2013

(30) Foreign Application Priority Data
Jun. 28, 2012 (JP) 2012-146069

(51) Int. Cl. A63F 13/12

(52) U.S. Cl. CPC A63F 13/12
USPC 463/31

(57) ABSTRACT

An electronic device receives, from a server, corresponding operation data that indicates a corresponding operation for operation input. Also, in a case where detected operation input is operation input for an operation for which it is predetermined that responsiveness of a corresponding operation to be performed in response to the operation input, the electronic device executes the corresponding operation data corresponding to the detected operation input.

### BACKGROUND OF THE INVENTION

1. Field of the Invention

The present invention relates to an electronic device, a control method thereof, and recording medium, and particularly to a streaming distribution technique for encoded video data.

2. Description of the Related Art

The present invention relates to an electronic device, a control method, a recording medium, and particularly to a technique of loading static data into shared memory.

### BACKGROUND ART

Client devices such as personal computers (PCs) capable of network connection have become widespread. Along with the widespread use of devices, the network population of the Internet is increasing. Various services using the Internet have recently been developed for network users, and entertainment services such as games are also provided.

One of the services for network users is a multiuser online network game such as MMORPG (Massively Multiplayer Online Role-Playing Game). In a multiuser online network game, a user connects his/her client device to a server that provides the game, thereby doing match-up play or team play with another user who uses another client device connected to the server.

In a general multiuser online network game, each client device sends/receives data necessary for game rendering to/from the server. The client device performs rendering processing using the received data necessary for rendering and presents the generated game screen to a display device connected to the client device, thereby providing the game screen to the user. Information the user has input by operating an input interface is sent to the server and used for calculation processing in the server or transmitted to another client device connected to the server.

However, some network games that cause a client device to perform rendering processing require a user to use a PC having sufficient rendering performance or a dedicated game device. For this reason, the number of users of a network game (one content) depends on the performance of the client device required by the content. A high-performance device is expensive, as a matter of course, and the number of users who can own the device is limited. That is, it is difficult to increase the number of users of a game that requires high rendering performance, for example, a game that provides beautiful graphics.

In recent years, however, there are also provided games playable by a user without depending on the processing capability such as rendering performance of a client device. In a game as described in International Publication No. 2009/138878, a server acquires the information of an operation caused in a client device and provides, to the client device, a game screen obtained by performing rendering processing using the information.

In a game as described in above mentioned International Publication No. 2009/138878, because data communication is performed over a network, a time lag in the response of a game screen displayed in response to operation input will necessarily occur. Specifically, regarding operation that a user performed on an operation interface such as a game pad connected to a client device, operation input is analyzed on the client device and converted into operation input data suitable for the game. The obtained operation input data is transmitted to a server device and is used for updating of the state of the game on the server device. On the server device, generation of a game screen is performed for the game state after updating, and the corresponding game screen is converted into encoded video data and transmitted to the client device. Finally, on the client device, decoding processing is carried out on the encoded video data, and the obtained game screen is displayed on a display device. In other words, because between the time that operation is made by the user and the time that in response to that operation an updated game screen is provided to the user, various data processing is performed spanning a network, it is difficult to avoid a time lag in response from occurring.

Thus, in a case where a game screen, updated in response to user operation, is delayedly provided with a time lag, this may cause the user's interest to wane. In particular, delayed provision of an updated game screen of a GUI for command selection which is accompanied by screen transition or of an action game may be disadvantageous. That is, this kind of problem may be particularly apparent in games for which responsiveness to operation input is required.

### SUMMARY OF THE INVENTION

The present application was made in view of such problems in the conventional technique. The present invention provides an electronic device which suitably provides, in a content providing system, a content service for which responsiveness to operation input is required wherein a screen generated on a server device is provided to client device in the system, a control method and a recoding medium.

According to one aspect of the present invention, there is provided an electronic device that receives operation input for content that a server provides, wherein the server transmits a screen rendered according to the operation input to a device different to the electronic device, and the electronic device comprises: a receiving unit configured to receive from the server, and store in a storage unit, corresponding operation data that indicates a corresponding operation for operation input; a detection unit configured to detect operation input made on the electronic device; a corresponding operation execution unit configured to read out from the storage unit, and execute, in a case where operation input detected by the detection unit is operation input for a predetermined operation that responsiveness of a corresponding operation to be performed in response to the operation input is required, the corresponding operation data for the detected operation input; and a transmission unit configured to transmit operation data detected by the detection unit to the server.

According to another aspect of the present invention, there is provided a control method of an electronic device that receives operation input for content that a server provides, wherein the server transmits a screen rendered according to the operation input to a device different to the electronic device, and the electronic device, the control method of the electronic device comprising: a receiving step in which a receiving unit of the electronic device receives from the server, and stores in a storage unit, corresponding operation data that indicates a corresponding operation for operation input; a detection step in which a detection unit of the electronic device detects operation input made on the electronic device; a corresponding operation execution step in which a corresponding operation execution unit reads out from the storage unit, and executes, in a case where operation input detected in the detection step is operation input for a predetermined operation that responsiveness of a corresponding operation to be performed in response to the operation input is required, the corresponding operation data for the detected operation input; and a transmission step in which a transmission unit transmits operation data detected in the detection step to the server.

Further features of the present invention will become apparent from the following description of exemplary embodiments (with reference to the attached drawings).

### BRIEF DESCRIPTION OF THE DRAWINGS

FIG. 1 is a view that illustrates a system configuration of a game system according to an embodiment of the present invention.

FIG. 2 is a block diagram that illustrates a functional configuration of a portable terminal 100 according to an embodiment of the present invention.

FIG. 3 is a block diagram that illustrates a functional configuration of a server 200 according to an embodiment of the present invention.

FIG. 4 is a block diagram that illustrates a functional configuration of a PC 300 according to an embodiment of the present invention.

FIG. 5 is a flow chart that exemplifies game processing that is performed in a game system according to an embodiment of the present invention.

FIG. 6 is a flow chart that exemplifies on-terminal processing that is performed on the portable terminal 100 according to an embodiment of the present invention.

FIGS. 7A and 7B are views for explaining information that is managed in the server 200 according to an embodiment of the present invention.

### DESCRIPTION OF THE EMBODIMENTS

The details of exemplary embodiments of the present invention will be explained referring to the drawings. Note, an embodiment explained below is an example in which the present invention is applied to an example of a content providing system including a server 200 which distributes game content, a portable terminal 100 functioning as a first device that receives an operation input, and a PC 300 functioning as a second device that displays a screen distributed from the server.

<Configuration of the Game System>

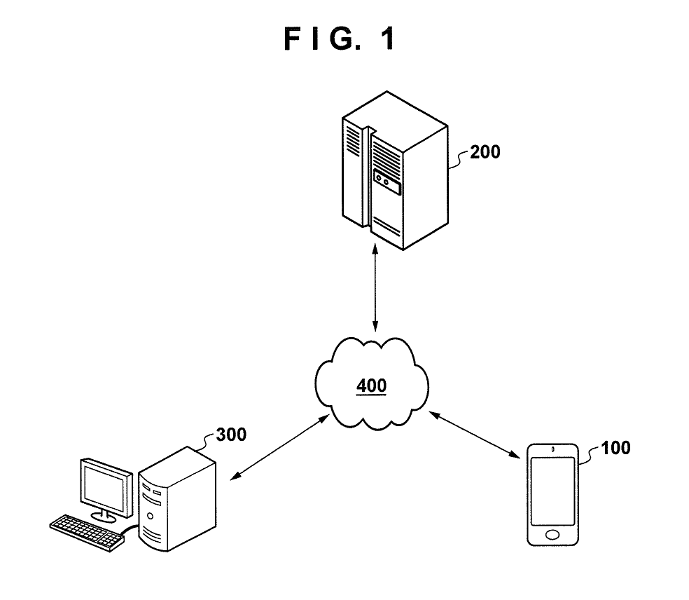

FIG. 1 is a view that illustrates a system configuration of a game system according to an embodiment of the present invention.

As shown in the FIG. 1, the server 200 and the portable terminal 100, and the server 200 and the PC 300 are connected via a network 400 such as the Internet. In the present embodiment, the server 200 provides, via the network 400, game content that can be tried. In the present embodiment, the server 200 provides different features of game content respectively to the portable terminal 100 and to the PC 300.

As mentioned above, in game systems in which data is exchanged over a network, there necessarily is a time lag from the time that operation input is performed to the time that a game screen updated according to this operation input is provided to a user. In particular, it is difficult to get rid of the influence of a time lag for a game screen that is provided using the rendering capability of the server 200, such as a main game screen provided as game content (a screen in which a game field, a character or the like is displayed).

Meanwhile, it is difficult for a user to recognize whether an operation input was performed correctly in the case where for a secondary game screen, for which responsiveness of display update is required, is provided through rendering processing on the server 200, such as a command determination screen for which screen transition is performed in accordance with operation input. Accordingly, there is the possibility that this will cause the user's interest to wane. For this reason, in the game system of the present embodiment, game content features are provided to the portable terminal 100 and to the PC 300 having been separated based on whether or not a time lag is acceptable. Specifically, a feature corresponding to display of a main game screen, for which responsiveness to operation input is not required, is provided to the PC 300. Also, an operation input detection function or a function corresponding to display of a secondary game screen, for which responsiveness to operation input is required, is provided to the portable terminal 100. Note, in the game system of the present embodiment, it is preferable that the game content provided by the server 200 be game content of a type in which after a finale command is determined, a corresponding game screen is displayed, rather than a game, such as a so-called action game, for which responsiveness is required for a main game screen, but embodiment of the invention is not limited to this.

Also, in the present embodiment, explanation is made using the portable terminal 100 and the PC 300 as client devices that connect to the server 200, but embodiment of the invention is not limited to this. For example, the portable terminal 100 may be a device, such as a portable game device, a mobile phone, a PDA, a tablet or the like, having a communication function, an operation input search function, and preferably an image rendering function. Also, the PC 300 may be a device, such as a game console, a set top box, a portable game device, a PDA, a tablet or the like, having a communication function and the ability to decode and playback encoded video data.

Note, in embodiments of the present invention, data communication between the portable terminal 100 and the PC 300 is not necessary, and the user may use the game content provided by the server 200 on the portable terminal 100 and the PC 300 as though they were being synchronized.

<Configuration of the Portable Terminal 100>

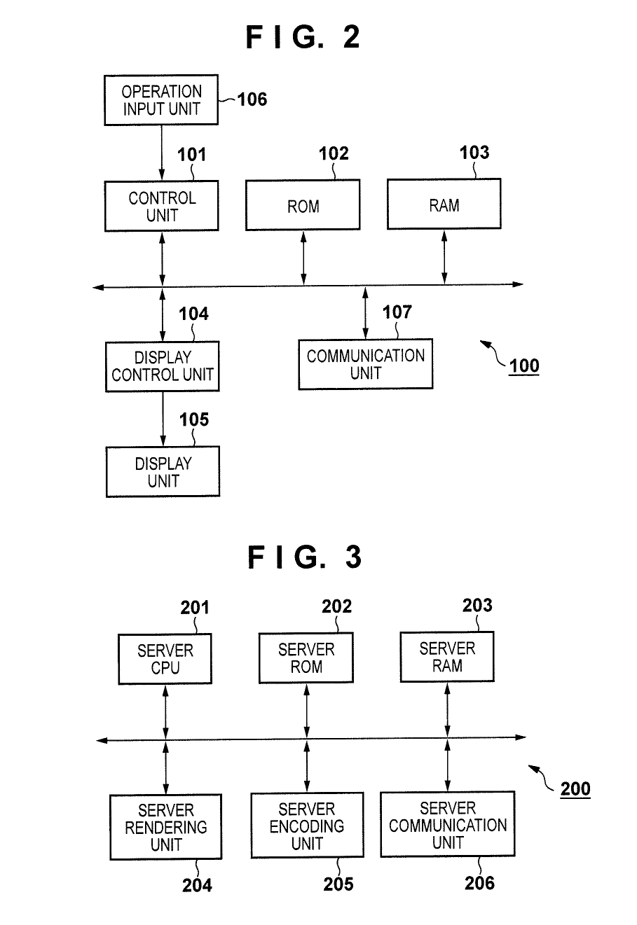

FIG. 2 is a block diagram that illustrates a functional configuration of the portable terminal 100 according to an embodiment of the present invention.

A control unit 101 is for example a CPU or the like. The control unit 101 controls the operation of each block in the portable terminal 100. Specifically, the control unit 101 controls the operation of each block by, for example, reading out an operation program for the block stored in a ROM 102, loading it into a RAM 103 and executing it. The ROM 102 is, for example, a rewritable, non-volatile memory. The ROM 102 stores, on top of an operation program for each block in the portable terminal 100, information such as parameters necessary for the operation of each block. In the parameters, information such as a MAC address which individually identifies the portable terminal 100 may be included. Also, in the present embodiment, a program corresponding to a web browser application is stored in the ROM 102.

The RAM 103 is a volatile memory. The RAM 103 functions not only as an area to load operation programs of the blocks in the portable terminal 100, but also as a storage area in which such things as intermediate data output in the operation of the blocks is stored. In the present embodiment, data received from the server 200 due to access of the server 200 in a web browser application is buffered in the RAM 103.

A display unit 105 is a display apparatus of the portable terminal 100 such as, for example, an LCD or the like. Presentation of images to the display unit 105 is controlled by a display control unit 104.

An operation input unit 106 is a user interface including, for example, a button (not shown) of the portable terminal 100. When the operation input unit 106 detects a user operation input on a user interface, it transmits a control signal corresponding to the operation details to the control unit 101. Note, in the present embodiment, the display unit 105 may be a touch panel display, in which case user touch input (depending on the detection method, this may include non-touching proximity input) made on the surface of the display unit 105 is detected by the operation input unit 106.

A communication unit 107 is a communication interface of the portable terminal 100. In the present embodiment, the user can initiate data communication by launching a web browser application on the portable terminal 100 and connecting to the server 200 via the communication unit 107.

<Configuration of the Server 200>

FIG. 3 is a block diagram that illustrates a functional configuration of the server 200 according to an embodiment of the present invention. A server CPU 201 controls the operation of each of the blocks in the server 200. Specifically, the server CPU 201 controls the operation of each block by, for example, reading out an operation program for the block stored in a server ROM 202, loading it into a server RAM 203 and executing it.

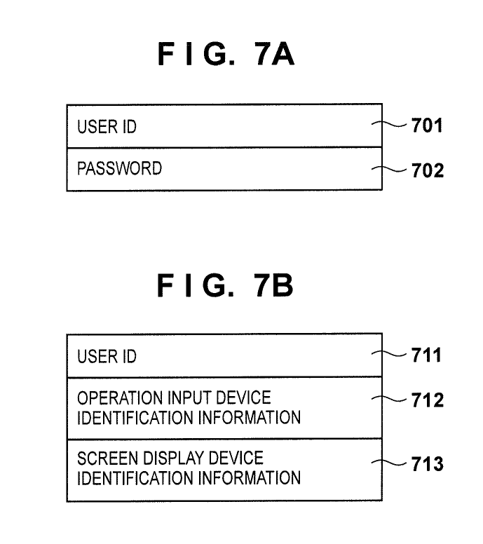

The server ROM 202 is, for example, a rewritable, non-volatile memory. The server ROM 202 stores, on top of an operation program for each block in the server 200, information such as parameters necessary for the operation of each block. In the present embodiment, account information of users of a service that the server 200 provides is managed in the server ROM 202. The account information may be managed with, for example, a password 702 associated with a user ID 701 as shown in FIG. 7A.

The server RAM 203 is a volatile memory. The server RAM 203 functions not only as an area to load operation programs of the blocks in the server 200, but also as a storage area in which such things as intermediate data output in the operation of the blocks is stored. In the present embodiment, information of the devices used (the portable terminal 100 and the PC 300) for users that are currently using a service is managed in the server RAM 203. Specifically, as shown in FIG. 7B, operation input device identification information 712 and screen display device identification information 713 is associated with a user ID 711 and managed in the server RAM 203. Note, device identification information may be identification information unique to the device by which the server 200 can individually identify it such as, for example, a MAC address of the device.

A server rendering unit 204 is, for example, a GPU, which renders game screens for game content provided as a service. For example, in a case where content is provided as a 3 dimensional game screen, the server rendering unit 204 receives information of rendering objects included in the rendering scope from the server CPU 201, and generates game screens by sequentially rendering into VRAM (not shown).

A server encoding unit 205 generates encoded video data by encoding game screens generated by the server rendering unit 204. In the present embodiment, a game screen provided to the PC 300 by the server 200 is transmitted as a frame of video data encoded in a predetermined format. This is in order to reduce the transferred data size for the provision of a game screen, but embodiment of the present invention is not limited to a method of providing game screens.

A server communication unit 206 is a communication interface of the server 200. The server 200 can function as a Web server and perform data communication with external devices via the server communication unit 206. In the present embodiment, the server 200 transmits, in a streaming method, encoded video data generated in the server encoding unit 205 to the PC 300.

<configuration of the PC 300>

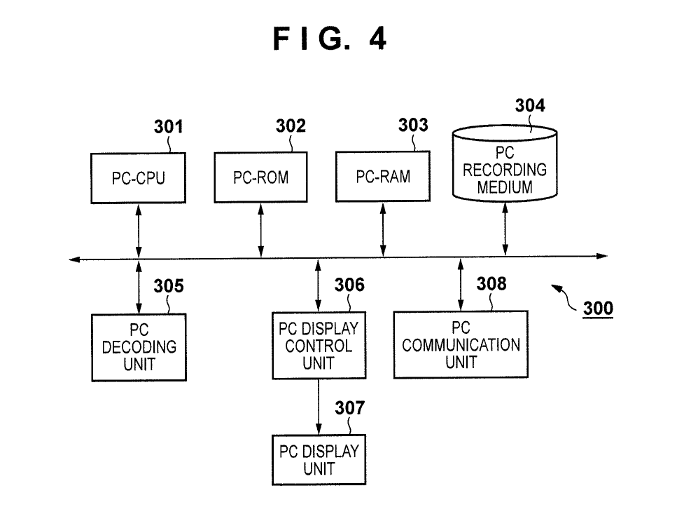

FIG. 4 is a block diagram that illustrates a functional configuration of the PC 300 according to an embodiment of the present invention. A PC CPU 301 controls the operation of each block in the PC 300. Specifically, the PC CPU 301 controls the operation of each block by, for example, reading out an operation program for the block stored in a PC ROM 302 or a PC recording medium 304, loading it into a PC RAM 303 and executing it.

The PC ROM 302 is, for example, a rewritable, non-volatile memory. The PC ROM 302 stores, on top of an operation program for each block in the PC 300, information such as parameters necessary for the operation of each block. Similarly to the case of the portable terminal 100, the parameters include individual identification information of the PC 300.

The PC RAM 303 is a volatile memory. The PC RAM 303 functions not only as an area to load operation programs of the blocks in the PC 300, but also as a storage area in which such things as intermediate data output in the operation of the blocks is stored.

The PC recording medium 304 is a recording device connected to the PC 300 such as, for example, an HDD. The PC recording medium 304 may store a program for a web browser application which causes blocks in the PC 300 to operate.

A PC communication unit 308 is a communication interface of the PC 300. The PC 300 communicates with the server 200 via the PC communication unit 308. In the present embodiment, the PC communication unit 308 receives encoded video data generated by the server 200.

A PC decoding unit 305 generates game screens to provide to a user by decoding encoded video data received from the server 200. Obtained game screens are transmitted to a PC display control unit 306.

A PC display unit 307 is, for example, an LCD that is built into the PC 300, or is a display apparatus connected to the PC 300. Screen provision to the PC display unit 307 is controlled by the PC display control unit 306. In the present embodiment, the PC display control unit 306 provides game screens decoded by the PC decoding unit 305 to the PC display unit 307.

<Game Processing>

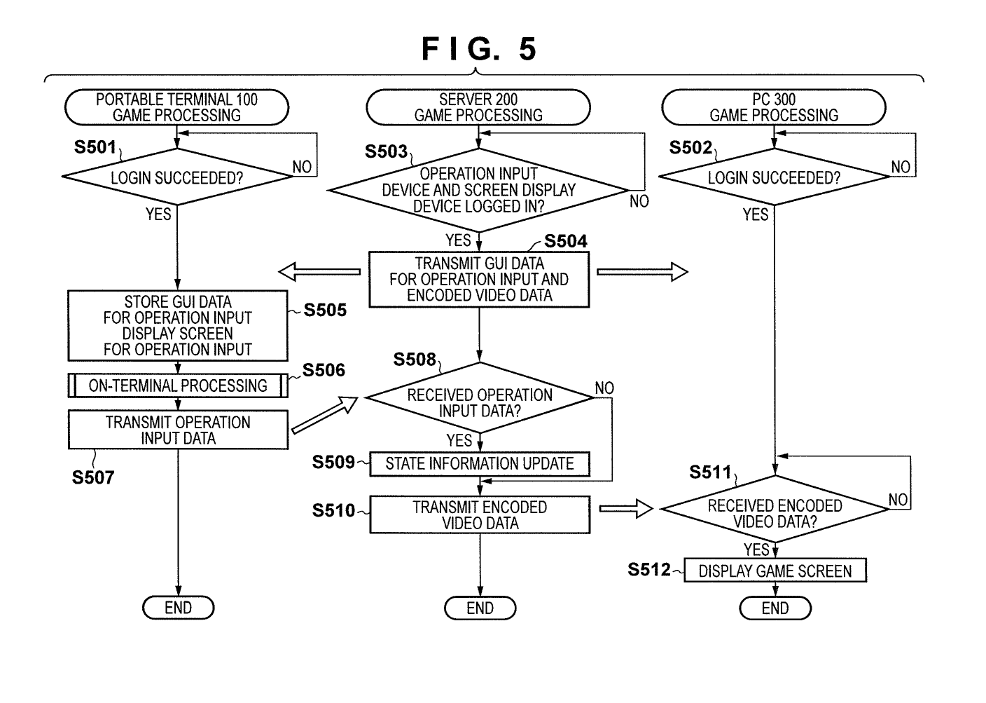

Specific processing will be explained using the flow chart in FIG. 5 for game processing in the game system of the present embodiment having this kind of configuration. Processing corresponding to this flowchart is performed by the control unit 101, the server CPU 201 or the PC CPU 301. Note, this game processing will be explained as something that is initiated when a user launches a web browser application on the portable terminal 100 or the PC 300 and accesses the server 200.

Firstly, in step S501, the control unit 101 receives input of account information from the user, and determines whether or not login to a service provided by the server 200 succeeded. Specifically, the control unit 101 determines whether or not login to a service succeeded by determining whether or not the communication unit 107 received, for example, a return message when the login succeeded from the server 200 indicating that the login succeeded. When the control unit 101 determines that login to a service did succeed, it moves the processing on to step S505, and in the case where the login did not succeed, it repeats the processing of this step.

In step S502, the PC CPU 301 receives account information input from the user and determines whether or not login to a service that the server 200 provides succeeded. Specifically, the PC CPU 301 determines whether or not login to a service succeeded by determining whether or not the PC communication unit 308 received, for example, a return message when the login succeeded from the server 200 indicating that the login succeeded. When the PC CPU 301 determines that login to a service did succeed, it moves the processing on to step S511, and in the case where login did not succeed, it repeats the processing of this step.

In step S503, the server CPU 201 determines whether or not login to a service succeeded on both an operation input device (the portable terminal 100) and a screen display device (the PC 300) for a user ID that is a target of service provision. Specifically, when there is a request to login to a service, the server CPU 201 checks the validity of account information included in the login request. Next, in a case where the validity of a login request was confirmed, the server CPU 201 associates the user ID that is logging in, and identification information of the device being used to log in, and stores this in the server RAM 203.

Note, in the present embodiment, the types of devices that can be operation input devices and devices that can be screen display devices are predetermined. When the server CPU 201 receives a login request from a target device, the server CPU 201 determines what device is being used for the login, associates identification information of the device as information corresponding to either operation input device identification information or screen display device identification information with the user ID, and stores this in the server RAM 203. However, embodiment of the present invention is not limited to this, and a configuration may be taken in which 2 devices are registered by selecting whether to login the device as an operation input device or a screen display device when logging in to the server 200.

In a case where the server CPU 201 determines that login has succeeded for both an operation input device and a screen display device for a provision target user ID, it moves the processing to step S504, and when it determines that login has not succeeded for both devices, it repeats the processing of this step.

In step S504, the server CPU 201, transmits GUI data for game content operation input from the server communication unit 206 to the portable terminal 100 registered as an operation input device. Note, the GUI data for operation input is not fixed image data but rather it is at least GUI data for a screen for multiple operation input that can correspond to screen transition according to operation input. Also, regarding the GUI data provided to the portable terminal 100, different GUI data may be provided in accordance with a game procedure, such as, for example, a change due to an operation character level increasing.

Also, in this step, the server CPU 201 initiates provision of encoded video data to the PC 300 registered as the screen display device. Specifically, the server CPU 201, after causing the server rendering unit 204 to render a game screen according to state information indicated by the current game procedure, causes encoded video data to be generated by causing the server encoding unit 205 to encode the obtained game screen. Next, the server CPU 201 transmits the generated encoded video data to the server communication unit 206, which transmits it to the PC 300.

The server CPU 201, after executing this step, moves the processing on to step S508.

In the step S505, the control unit 101 stores GUI data for operation input received from the server 200 in the RAM 103. Next, the control unit 101 transmits a secondary screen for operation input generated using the GUI data, out of stored GUI data, that corresponds to current state information to the display control unit 104, thereby causing it to be displayed on the display unit 105. Note, regarding state information indicating current game procedure, at least information necessary for defining a secondary screen for operation input is provided from the server 200 to the portable terminal 100. Also, the secondary screen is provided over a web browser application launched on the portable terminal 100.

In step S06, the control unit 101 performs on-terminal processing that determines whether or not to transmit operation input done by the user on the portable terminal 100 to the server 200. The details of this on-terminal processing are described later. However, in the present embodiment, by performing on-terminal processing on the portable terminal 100, it is possible to transmit operation details for operation input made on the portable terminal 100 to the server 200 only in a case where they need to be reflected in a game screen. In other words, for operation input that does not need to be reflected in a game screen, the control unit 101 can complete processing corresponding to the operation input within the portable terminal 100.

In step S07, the control unit 101 converts information of operation input performed on the portable terminal 100 according to a data management format of the game content and transmits it as operation input to the server 200 via the communication unit 107. The conversion processing performed in this step is processing that converts information of a coordinate (or of a trajectory) upon which operation input is detected in analog on a touch panel, for example, into game data such as a selected command, a movement direction or the like.

In step S508, the server CPU 201 determines whether or not operation input data was received from the portable terminal 100 in the server communication unit 206. In a cases where the server CPU 201 determines that operation input data was received, it moves the processing on to step S509, and in the case where it determines operation input data was not received it moves the processing on to step S510.

In step S509, the server CPU 201 updates state information stored in the server RAM 203 according to the operation input data.

In step S510, the server CPU 201, after causing the server rendering unit 204 to render a game screen according to the state information stored in the server RAM 203, causes generation of encoded video data by causing the server encoding unit 205 to encode the obtained game screen. Next, the server CPU 201 transmits the generated encoded video data to the server communication unit 206, which transmits it to the PC 300.

In step S511, the PC CPU 301 determines whether or not encoded video data was received from the server 200 in the PC communication unit 308. In a case where the PC CPU 301 determines that encoded video data was received it moves the processing on to set 5512, and when it determines that encoded video data was not received, it repeats the processing of this step.

In the step S512, the PC CPU 301 causes generation of a game screen corresponding to the current frame by causing the PC decoding unit 305 to decode the received encoded video data. Next, the PC CPU 301 transmits the generated game screen to the PC display control unit 306, thereby causing it to be displayed on the PC display unit 307.

In this way, in the game system of the present embodiment, it is possible to assign the roles of an operation input device and a screen display device for game content that is provided by the server 200 to different devices on a network. Note, in this game processing, the processing of steps S506 through S512 is repetitively performed according to a generation time interval of game screens the server 200 provides.

<n-Terminal Processing>

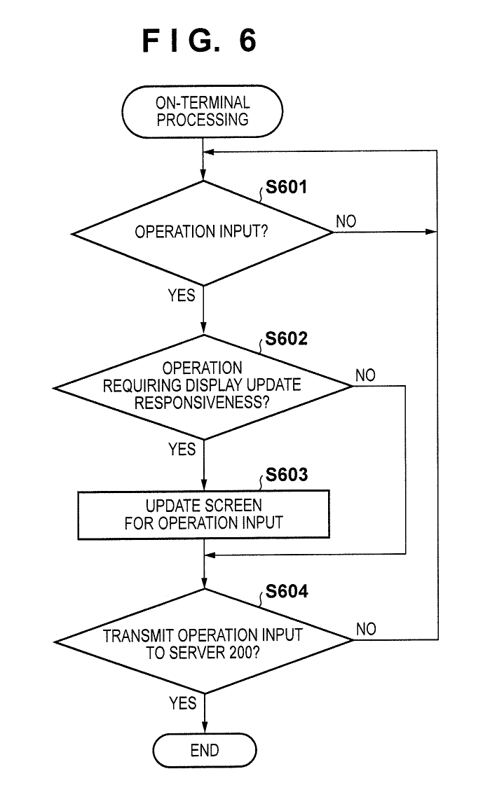

FIG. 6 is a flow chart that exemplifies on-terminal processing that is performed in the portable terminal 100 according to an embodiment of the present invention. Processing corresponding to this flow chart can be realized by the control unit 101, reading out a corresponding processing program recorded in, for example, the ROM 102, loading it into the RAM 103 and executing it.

In step S601, the control unit 101 determines whether or not operation input was made by a user. Specifically, the control unit 101 make the determination based on whether or not it received a control signal corresponding to operation input from the operation input unit 106. In the case where the control unit 101 determines that operation input was made by a user, it moves the processing on to step S602, and when it determined that operation input was not made, it repeats the processing of this step.

In step S602, the control unit 101 analyzes the control signal corresponding to the operation input and determines whether or not the operation input made by the user is operation input that corresponds to an operation for which it is predetermined that responsiveness of display updating in response to operation input is required. Operation for which responsiveness of screen updating in response to operation input is required may be, for example:

selection of a command sorted hierarchically;

display of input trajectory on a touch panel; or

status change due to use of an item,

or the like. Note, information of an operation for which responsiveness of screen updating is required is something that is provided to the portable terminal 100 from the server 200.

The control unit 101 moves the processing on to step S603 in the case where it determines that the operation input made by the user is operation input for which responsiveness of screen updating is required, and moves the processing on to step S604 in the case where it determines that it is operation input for which responsiveness of screen updating is not required.

In step S603, the control unit 101 reads GUI data, corresponding to the operation input detected in step S601, from amongst GUI data for operation input stored in the RAM 103. Next, the control unit 101 transmits a secondary screen for operation input generated using the read out GUI data to the display control unit 104, thereby causing it to be displayed on the display unit 105.

In step S604, the control unit 101 determines whether or not to transmit the operation input made by the user to the server 200. This determination may be carried out according to whether or not, for example, a final determination of a command, or the completion of continued input on a touch panel was detected. In a case where the control unit 101 determines that it will transmit the operation input to the server 200, it completes the on-terminal processing, and when it determines that it will not transmit the operation input, it returns the processing to step S601.

Thus, on the portable terminal 100 in the present embodiment, in a case where operation input for which responsiveness of screen updating is required is made, by updating display on the display unit 105, a suitable response display can be provided without a time lag to the user in response to operation input.

Note that while in the present embodiment, example was given of usage of game content provided by the server 200 in which an operation input device and a screen display device were separate, embodiment of the present invention is not limited to this. For example, the content provided by the server 200 is not limited to game content, and may be video of a video distribution service such as so-called VOD. In this case, the operation input device may provide a playback control UI or a playback content selection function, and may, for example, carry out the updating of a GUI on the operation input device when a current progress position is changing on a progress bar.

Also, while in the present embodiment, explanation was made using display updating as the only operation for which responsiveness to operation input was required, the present invention is not limited to this. Corresponding operation carried out in response to operation input may be, for example, audio playback corresponding to operation input, or the vibration of an operation input device using a motor, etcetera. In this case, information of the audio data to be played back or the vibration pattern is provided beforehand to the operation input device to the server 200.

As explained above, with the content providing system of the present embodiment it is possible to suitably provide a content service for which responsiveness to operation input is required. Also, because a general purpose application such as a web browser application can be used to realize the system, a user need not purchase multiple specific devices in order to use the content. Furthermore, because there is no need to provide a custom communication function between the operation input device and the screen display device, the service can be provided without using a platform that supports communication between these devices.

This application claims the benefit of Japanese Patent Application No. 2012-146069, filed Jun. 28, 2012, which is hereby incorporated by reference herein in its entirety.

What is claimed is:

1. An electronic device that receives operation input for content that a server provides, wherein the server transmits a screen rendered according to the operation input to a device different to the electronic device, and the electronic device comprises:
a receiving unit configured to receive from the server, and store in a storage unit, corresponding operation data that indicates a corresponding operation for operation input;
a detection unit configured to detect operation input made on the electronic device;
a corresponding operation execution unit configured to read out from the storage unit, and execute, in a case where operation input detected by the detection unit is operation input for a predetermined operation that responsiveness of a corresponding operation to be performed in response to the operation input is required, the corresponding operation data for the detected operation input; and
a transmission unit configured to transmit operation data detected by the detection unit to the server.

2. The electronic device according to claim 1, further comprising a determination unit configured to determine whether or not to transmit to the server operation input detected by the detection unit,
wherein in a case where the determination unit determines that operation input is to be transmitted to the server, the first transmission unit generates, and sends to the server, the operation input data indicating the corresponding operation input.

3. The electronic device according to claim 1, further comprising:
a display unit configured to display data; and
a display control unit configured to control display of display data on the display unit,
the corresponding operation data is display data related to operation input,
the display control unit:
displays, on the display unit, at least a part of display data related to the operation input stored in the storage unit; and
in a case where the operation input detected by the detection unit is operation input for a predetermined operation for which responsiveness of a corresponding operation for operation input is required, converts display details of the display unit into display data corresponding to the detected operation input.

4. The electronic device according to claim 3, wherein
the display control unit is a browsing application, and
the display data related to the operation input is displayed onto the display unit by the browsing application.

5. The electronic device according to claim 1, wherein the corresponding operation includes an audio playback or a vibration of the electronic device.

6. A control method of an electronic device that receives operation input for content that a server provides, wherein the server transmits a screen rendered according to the operation input to a device different to the electronic device, and the electronic device, the control method of the electronic device comprising:
a receiving step in which a receiving unit of the electronic device receives from the server, and stores in a storage unit, corresponding operation data that indicates a corresponding operation for operation input;
a detection step in which a detection unit of the electronic device detects operation input made on the electronic device;
a corresponding operation execution step in which a corresponding operation execution unit reads out from the storage unit, and executes, in a case where operation input detected in the detection step is operation input for a predetermined operation that responsiveness of a corresponding operation to be performed in response to the operation input is required, the corresponding operation data for the detected operation input; and
a transmission step in which a transmission unit transmits operation data detected in the detection step to the server.

7. A computer-readable recording medium recording a program for causing a computer to function as each unit, other than the storage unit and the display unit, of the electronic device of claim 1.
